(19) United States
(12) Patent Application Publication
(10) Pub. No.: US 2012/0290442 A1
(43) Pub. Date: Nov. 15, 2012

(54) Computer Implemented System, Method and Computer Program Product for Identifying Consumer Design Categories

(75) Inventors: Fred Starr, Greensboro, NC (US); Rene Rodriguez, Kernersville, NC (US)

(73) Assignee: MyDesign, LLC, Greensboro, NC (US)

(21) Appl. No.: 13/499,408

(22) PCT Filed: Oct. 1, 2010
(86) PCT No.: PCT/US10/51127

§ 371 Date: Jun. 14, 2012

Related U.S. Application Data
(60) Provisional application No. 61/247,649, filed on Oct. 1, 2009.

(51) Int. Cl. G06Q 30/00

(52) U.S. Cl. 705/26.63

(57) ABSTRACT

A computer implemented system, method and computer program product for identifying a user's design categories for one or more products offered by one or more sellers of products. A plurality of questions can be displayed. Each question is associated with a plurality of choices. A user can be permitted to select one or more choices to the plurality of questions. An indication of at least one of the selected choices to one or more of the plurality of questions can be received. The selected choices comprise lifestyle preferences for the user. Multiple user design categories can be identified based on the user's lifestyle preferences. The user's multiple design categories can be displayed. Access can be provided to an incentive for the purchase products associated with the user's design categories. The incentive is activatable at a seller's retail location.

### CROSS-REFERENCE TO RELATED APPLICATIONS

This application claims the benefit of U.S. Provisional Application No. 61/247,649 filed Oct. 1, 2009, the entirety of which is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention generally relates to a computer-based system, method and computer program product comprising software for identifying and displaying a user's design categories, and providing correlating information regarding products within those design categories.

### BACKGROUND

Consumers are eager to reflect their unique personality in their purchases. In order to make the right decision based on their unique personalities, consumers may use various educational tools to translate their personal preferences into purchasing decisions. The shopping process for consumers typically involves gathering styling and product information through advertising and editorial information, store visits, and the Internet. Missing frequently is the step of first understanding personal lifestyle preferences based on their own personality, inspiration and lifestyle traits. Identifying these preferences may lead to confidence in product selection, greater shopping efficiencies, cost savings, and long-term satisfaction with the purchase of those products.

Retailers, however, have limited specific marketing tools that bridge the gap between the personal preferences of the consumer and the retailer's product offerings. Consequently, the consumer often shops without knowledge, experience, or confidence during the information gathering and decision-making process. Meanwhile, the retailer attempts, through current customer purchasing activity, aggregate sales history, and styling trend information, to have the right advertising, merchandising programs and products for sale. Due to the lack of information on individual consumer design category preferences, retailers develop product offering plans somewhat in the dark. There typically is no direct, on-going communication link between prospective customers and retailers, which provides a data-driven understanding of the retailers' markets.

Thus, there is a need for a new way to establish consumer-retailer relationships, and a method for maintaining that relationship with an on-going personalized communication system.

### SUMMARY OF THE INVENTION

The following presents a simplified summary of the invention in order to provide a basic understanding of some aspects of the invention. This summary is not an extensive overview of the invention and is not intended to identify key or critical elements of the invention or to delineate the scope of the invention. The purpose of this section is to present some concepts of the invention in a simplified form as a prelude to the more detailed description that is presented later.

In one embodiment, a computer-implemented system, method and computer program product for identifying a user's design categories for one or more products offered by one or more sellers of products can include the display, via a user interface, of a plurality of questions. Each of the plurality of questions can be associated with a plurality of choices. A user can be permitted to select one or more of the plurality of choices to one or more of the plurality of questions. An indication of at least one of the selected choices to one or more of the plurality of questions can be received. The selected choices can comprise lifestyle preferences for the user. The user's lifestyle preferences can be stored in a computer memory. Multiple user design categories can be indentified, via a computer processor, based on the user's lifestyle preferences. The user's multiple design categories can be stored in a computer memory. the user's multiple design categories can be displayed. Access can be provided to an incentive for the purchase of one or more products associated with the user's design categories, wherein the incentive is activatable at a seller's retail location.

In another embodiment, a computer-implemented system, method and computer program product for identifying a user's design categories for one or more products offered by one or more sellers of products can include the display, via a user interface, of a plurality of questions. Each of the plurality of questions can be associated with a plurality of choices. A user can be permitted to select one or more of the plurality of choices to one or more of the plurality of questions. An indication of at least one of the selected choices to one or more of the plurality of questions can be received. The selected choices can comprise lifestyle preferences for the user. The user's lifestyle preferences can be stored in a computer memory. Multiple user design categories can be indentified, via a computer processor, based on the user's lifestyle preferences. The user's design categories can be stored in a computer memory. The user's multiple design categories can be displayed. Access can be provided to information regarding one or more products associated with a seller that corresponds to the user's design categories.

In another embodiment, a computer-implemented system, method and computer program product for identifying a user's design categories for one or more products offered by one or more sellers of products can include the display, via a user interface, of a plurality of questions. Each of the plurality of questions can be associated with a plurality of choices. A user can be permitted to select one or more of the plurality of choices to one or more of the plurality of questions. An indication of at least one of the selected choices to one or more of the plurality of questions can be received. The selected choices can comprise lifestyle preferences for the user. The user's lifestyle preferences can be stored in a computer memory. The user's design categories can be indentified, via a computer processor, based on the user's lifestyle preferences. The user's design categories can be stored in a computer memory. Multiple design categories can be displayed. At least one message can be transmitted, via a communications network, to the user at least one message, the at least one message comprising information other than product offerings related to the user's multiple design categories.

In another embodiment, a computer-implemented system, method and computer program product for identifying a user's design categories for one or more products offered by one or more sellers of products can include the display, via a user interface, of a plurality of questions. Each of the plurality of questions can be associated with a plurality of choices. A user can be permitted to select one or more of the plurality of choices to one or more of the plurality of questions. An indication of at least one of the selected choices to one or more of the plurality of questions can be received. The selected choices can comprise lifestyle preferences for the user. The user's lifestyle preferences can be stored in a computer memory. Multiple user design categories can be indentified, via a computer processor, based on the user's lifestyle preferences. The user's design categories can be stored in a computer memory. The user's multiple design categories can be displayed. The user can be permitted to identify one or more alternate design categories.

### BRIEF DESCRIPTION OF THE DRAWINGS

FIG. 1 shows a system for identifying, displaying, and sending information regarding a a user's design categories in an embodiment of the invention.

FIGS. 2A through 2C shows another exemplary process for identifying, displaying, sending messages to a user regarding a user's design categories in an embodiment of the invention.

FIGS. 3A through 3K show exemplary screen displays for identifying and displaying the user's multiple design categories in an embodiment of the invention.

FIGS. 4A and 4B show exemplary screen displays for registering a user in an embodiment of the invention.

FIGS. 5A and 5B show exemplary screen displays for displaying a user's design categories, and products associated with the design categories in an embodiment of the invention.

### DETAILED DESCRIPTION

Reference will now be made in detail to the presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention cover such modifications and variations as come within the scope of the appended claims and their equivalents.

In one embodiment, an aspect of the invention can be a computer implemented system, method, and computer program product for identifying and displaying multiple user design categories, which can facilitate the shopping process for the consumer and a seller. A consumer can complete a questionnaire that identifies that individual's lifestyle preferences, which can be used to establish the consumer's preferred design categories. The design categories can be displayed along with products associated with the design categories. Various communications and incentives can be sent to the user to encourage the purchase of products at a seller. A seller as used herein means a product retailer, product wholesaler, product distributor, product manufacturer, or both product manufacturer and retailer, e.g., vertically-integrated retailers. The details of this computer implemented system, method, and computer program product will be described in more detail below.

### User Access and Host Websites

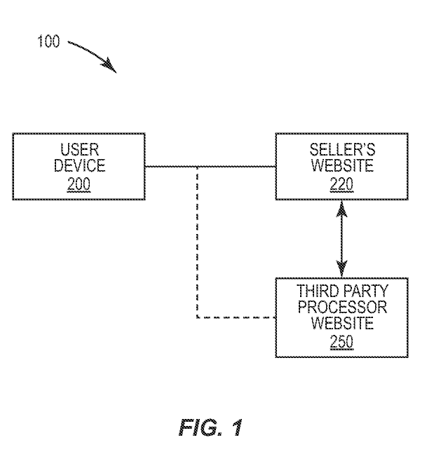

FIG. 1 shows a system for identifying, displaying, and sending information regarding a user's design categories, and for providing to the user an incentive for the purchase of the products at the seller's store. The system 100 can include a user device 200, seller's website 220 and a third party processor website 250. The user device 200 can be a data entry and display device that can include, but is not limited to, computer, terminal, workstation, PDA, tablet computer, iPad, Smartphone, iPhone, KIOSK, a retailer store device, or other any device that can be used to access a computer network. In an embodiment, the user device 200 can include a user interface running thereon that may be used to facilitate the identification and display of a user's design categories, as will be further described below.

The consumer uses the device 200 to access, via a communications network or electronic connection, the seller's website 220 to initiate the questionnaire and input his or her lifestyle preferences. The seller's website 220 can also be in electronic communication with the third party processor's website 250. In particular, the third party processor's website 250 can be a microsite within the seller's website 220. The third party website 250 can be displayed within a IFRAME tag embedded in the seller's website 220. The IFRAM tag refers to HTML markup language that permits the display of content within a frame from different URLs. The seller's website 220 can direct the user to the third party processor website 250. The seller's website 220 can be maintained and hosted by the seller's servers, for example. In other embodiments, however, the seller's website 200 can be hosted and maintained by a third party processor's servers, or vice versa. In another embodiment, the third party processor can be maintained and hosted by a third party processor's servers. In another an embodiment, a user device 200 can access, via a communications network or electronic connection, the third party processor's website 250 to input his or her lifestyle preferences.

Continuing with FIG. 1, the third party website 250 can display a plurality of questions and choices to the user. The user device 200 can allow a user to select answers or choices to the questions. The selected choices can indicate the lifestyle preferences for the user, as will be described below. The third party website 250 can receive the selected choices to the questions. The user's lifestyle preferences can be stored on a third party processor's server (not shown). The third party processor's server can include a computer processor (not shown) that identifies multiple user design categories based on the lifestyle preferences inputted by the user. The user's multiple design categories can be displayed on the third party website 250 for viewing by the user via the device 200. The third party processor can make available to the user an incentive for the purchase of the products at the seller's store. In an alternate embodiment, the seller's website 250 can receive the user's lifestyle preferences, identify the user's design categories based on the lifestyle preferences, and then provide access to an incentive for the purchase of products at the seller's store.

### Process Methodology

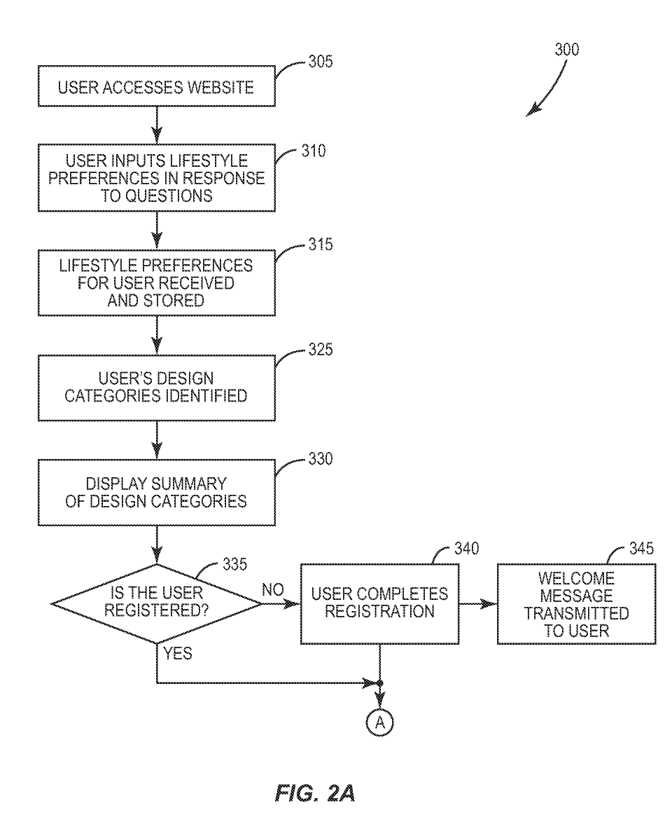

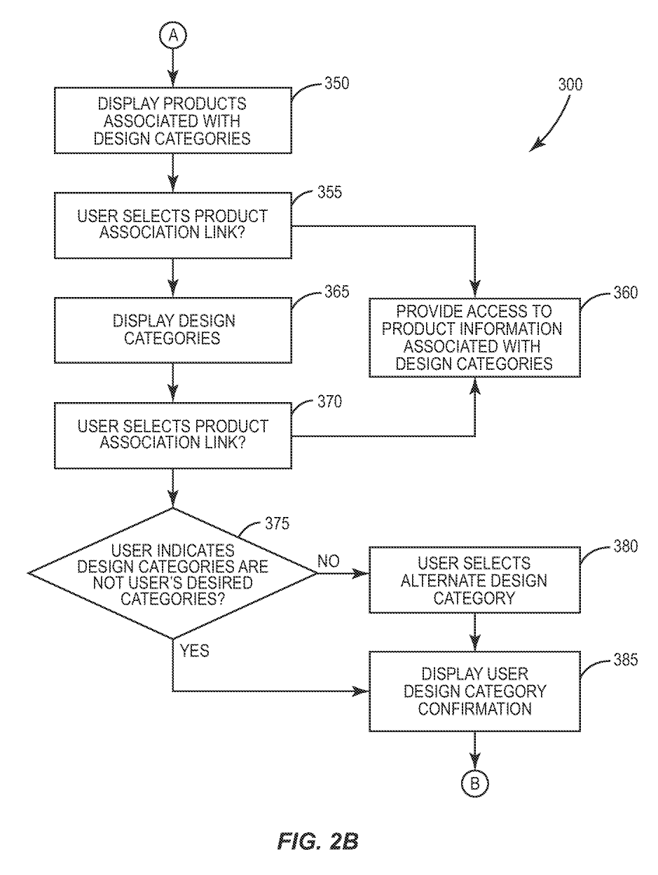

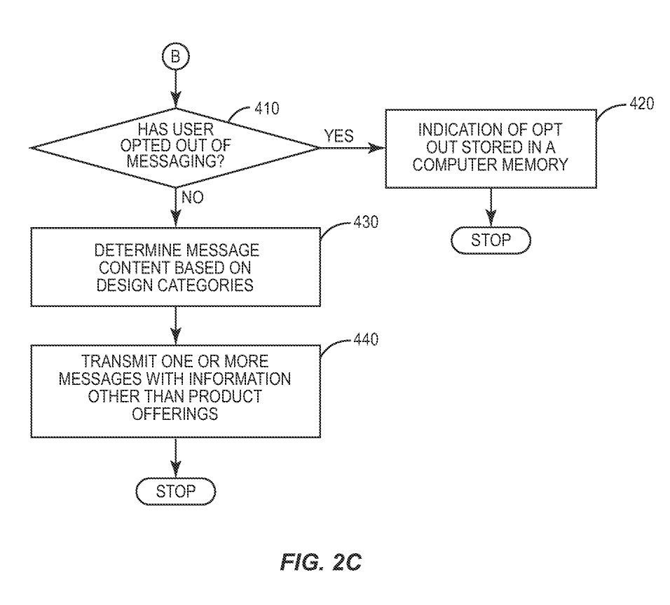

FIGS. 2A through 2C show a process 300 for identifying and displaying the user's design categories based on the users' lifestyle preferences, and then transmitting information regarding the user's design categories. As shown in FIG. 2A, the process 300 initiates when in step 305 a user accesses the seller's website 220 with the user device 200. The seller's website 200 can direct the user device 200 to the third party processor website 250. For example, the website 220 can include a link, that when selected by the user causes the third party processor website 250 to be displayed. The third party website 250, can cause the display of the plurality of questions. In step 310, the user can be permitted to input lifestyle preferences through the selection of the choices displayed with the plurality questions. As shown in step 315, the user's lifestyle preferences are received by the third party processor website 250 and stored in a computer memory. In alternate embodiments, as described above, the seller's website 250 can receive, store and process the user's lifestyle preferences in lieu of using third party websites, servers, or processors.

Continuing with FIG. 2A, as shown in step 325, the user's multiple design categories can be identified. Exemplary design categories can include, Transitional Traditional, Contemporary, Cottage, and Eclectic. The nomenclature used for the design categories, however, can be modified as the needed. For example, the design categories described in the exemplary questions below include Natural Elements, Casual Classics, Modern Expressions, Country Cottage and Eclectic. A computer program can determine the user's preference toward one, or any combination of Natural Elements, Casual Classics, Modern Expressions, Country Cottage or Eclectic as will be described below.

In one embodiment, the computer program identifies the user's design categories by assigning a weighted score for the user, for each design category. The user's score for each design category can be a percentage of the actual points the user's accumulates for each category, over the maximum points possible for each design category for each question. The development of the score can include “choice weighting” and “question weighting.” For example, a first value is associated each of the plurality of questions and a second plurality of values can be associated with each design category for each choice in the question. The actual points accumulated for each design category is the sum of the product the first value and the second value for each category, for each question. Based on the user's choices to the questions, the computer program can calculate the user's actual score for each category and for each question. The computer program correlates the user's preference to multiple design categories. The primary design category can be the design category with the highest percentage score. An example for calculating the user's score for one or more design categories is described in the section below entitled “Correlation of the Lifestyle Preferences to the Design Categories.”

As shown in FIG. 2A, in step 330, the computer program can display a preliminary summary of the design categories identified for the user. The summary of the design categories can be a descriptive text that indicates the design categories that received the highest scores based on the selection of the choices to the questions. For example, the summary may indicate that a user is a “mix of Natural Elements and Casual Classics.”

Continuing with FIG. 2A, in step 335, the computer program determines if the user is registered with a use database maintained by either the third party or seller. If the computer program determines that the user is registered, the user is directed to step 350 shown in FIG. 2B. If in step 335 the computer program determines that the user is not registered, the user is presented, in step 340, with a web page that encourages and facilitates registration. Registration may include inputting demographic information, e.g., the user's name, phone number, zip code, email address and other identifying information. In an embodiment, receipt of the registration information can be a prerequisite to the display of the user's design categories in step 365 discussed below. In other alternate embodiments, however, the registration step can occur upon the user's initial access to the seller's website 220. In step 345, a welcome message is transmitted to the user upon completion of registration. In other embodiments, this acknowledgement of registration message may include other information, e.g., a coupon redeemable through an in-store visit to a product seller, or design recommendations. However, the process can include additional messages regarding the user's design categories, as will be discussed in more detail below.

Turning to FIG. 2B, as shown in step 350, the process can display products associated with the user's design categories. The display can include a link, that when selected by the user, redirects the user to separate webpage with information regarding the products associated with the user's design categories. In an embodiment, an image of products associated with the user's design categories can be displayed. Clicking on hyperlinked image will direct the user to additional information about those product(s). In another embodiment, clicking on the hyperlinked image can present an enlarged image. In another embodiment, the display of associated products can include an image of home furnishings in a room. In other embodiments, the display of products can include an image or images of other products, e.g., apparel, automobiles, computer products, etc.

Continuing with FIG. 2B, as shown in step 355, the user can select a link associated with the displayed products described above. When the user selects the link in step 355, the computer program, as shown in step 360, can provide access to products that are associated with the user's design categories. For example the user device 200 may be directed to another portion of the seller's website 200. In another embodiment, the computer program provides access to product information associated with the user's primary design category. The product information can be a separate website, electronic file, PDF, or other electronic document that contains information regarding a seller's products.

In step 365, the process displays multiple design categories for the user via the user interface on the device 200. More than one design category for the user can be displayed. In addition, the user's primary design category can be displayed. Associated with the display of the design categories can be multiple images of products that are within one or more the user's design categories. The images can be a hyperlinked thumbnail image. In step 370, the user can select any one of the links associated with the displayed products. When the user selects the link in step 370, the computer program, as shown in step 360, can provide access to products that are associated with the user's design categories. Alternatively, the user progress to step 375.

Continuing with FIG. 2B, as shown in step 375, the user can indicate that the indentified and displayed design categories do not represent their desired design categories. If the computer program determines that the user does not agree that the displayed design categories are the ones desired, the process proceeds to step 380. The computer program can permit the user to select an alternate design category, to in effect, override the primary design category identified by the computer program. In an alternate embodiment, the computer program can permit the user to select more than one alternate design category. In step 380, the user can select an alternate design category or categories. In one embodiment, the alternate design category can be chosen by the user by selecting a hypertext link associated with a different design category. In another embodiment, the user can retake the questionnaire and input new choices to the questions. Retaking the questionnaire may result in a different correlation between the user's lifestyle preferences and the user's different design categories. Returning to step 375, if the computer program determines that the user agrees that the design categories are desired, the process proceeds to step 385. In step the 375, the user navigating to the next display within the IFRAME without selecting an alternate category or retaking the quiz indicates the user agrees with the user's design categories.

Providing the user with the ability to, in effect, override or re-designate her recommended design category is a feature of this invention. On occasion, the computer program will correctly identify the design category that most matches the user's lifestyle preferences, but the user expressly desires a different category for other reasons. Possibly the user is intending upon projecting a different look to her home, perhaps to purposely extend her own lifestyle surroundings. Alternatively, the user may wish to project a different look to satisfy the perceived preferences or social mores of her peers, family members, visitors or business associates.

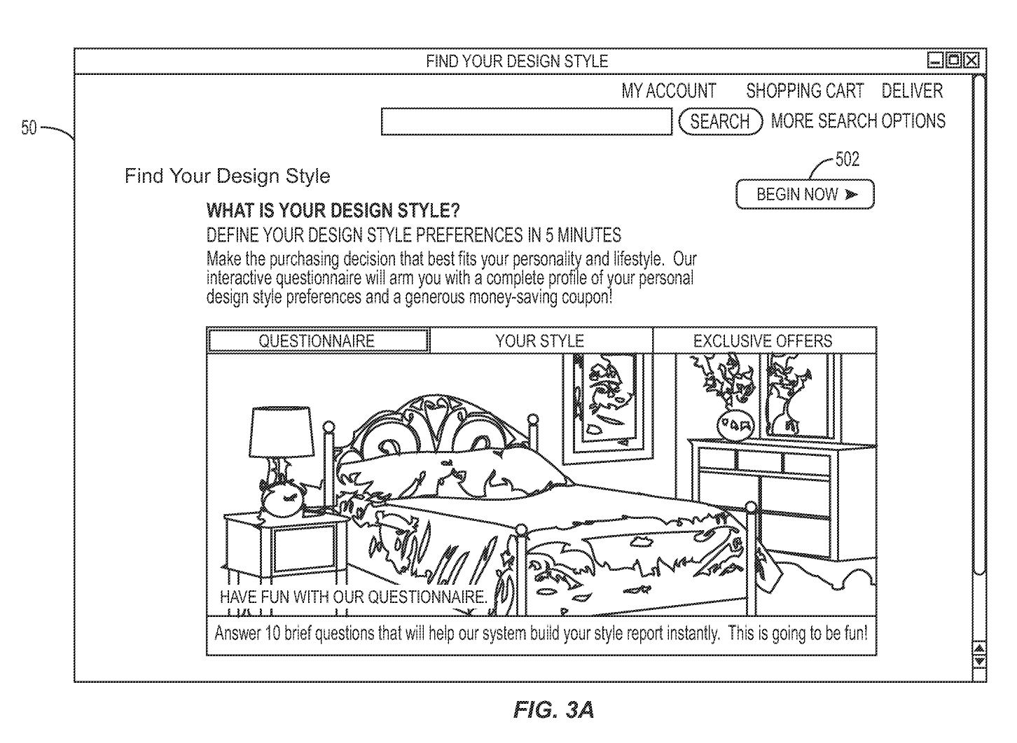

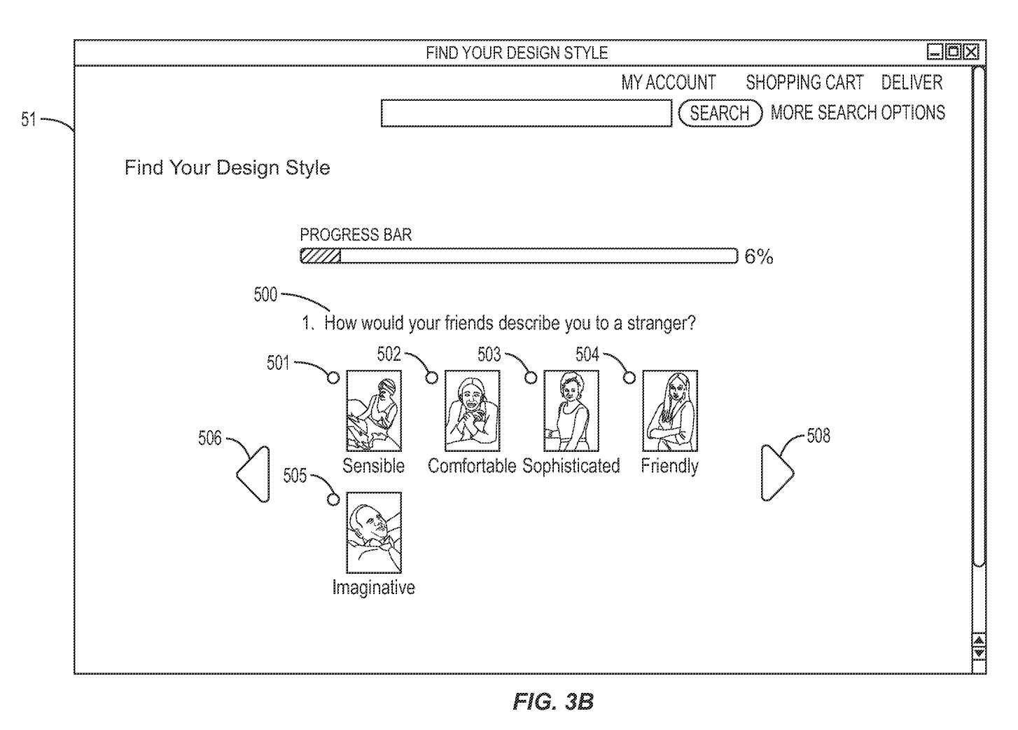

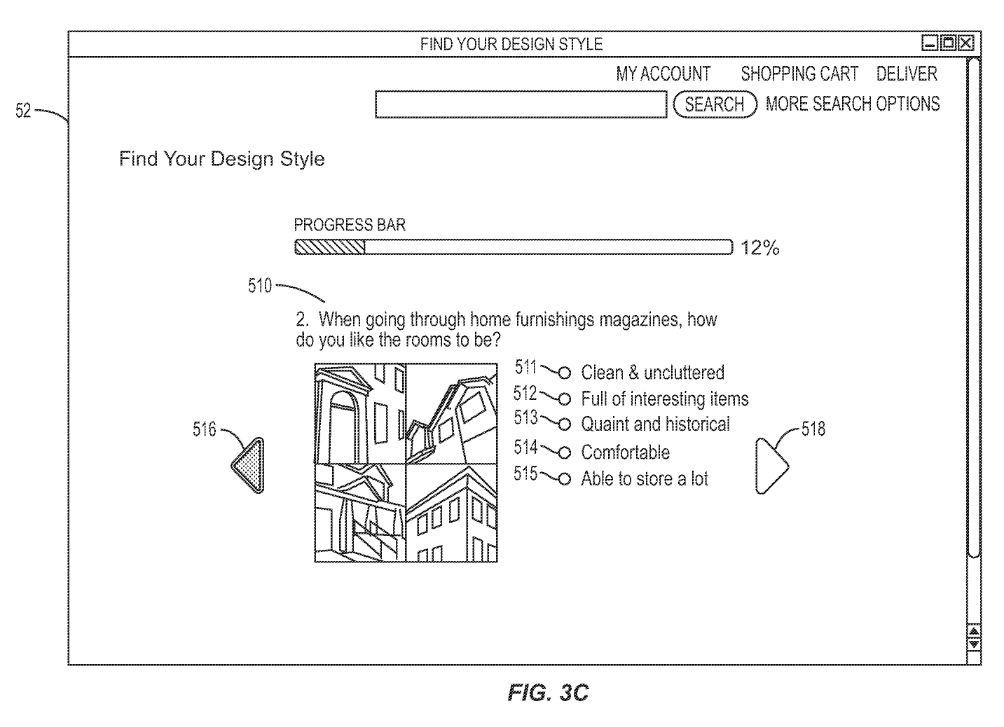

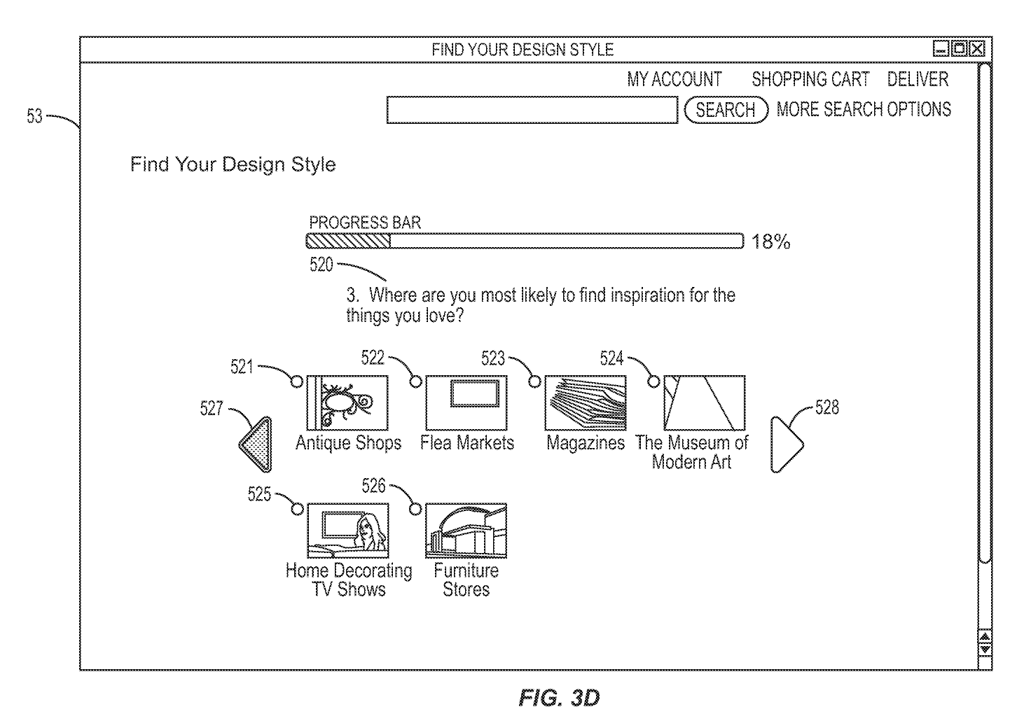

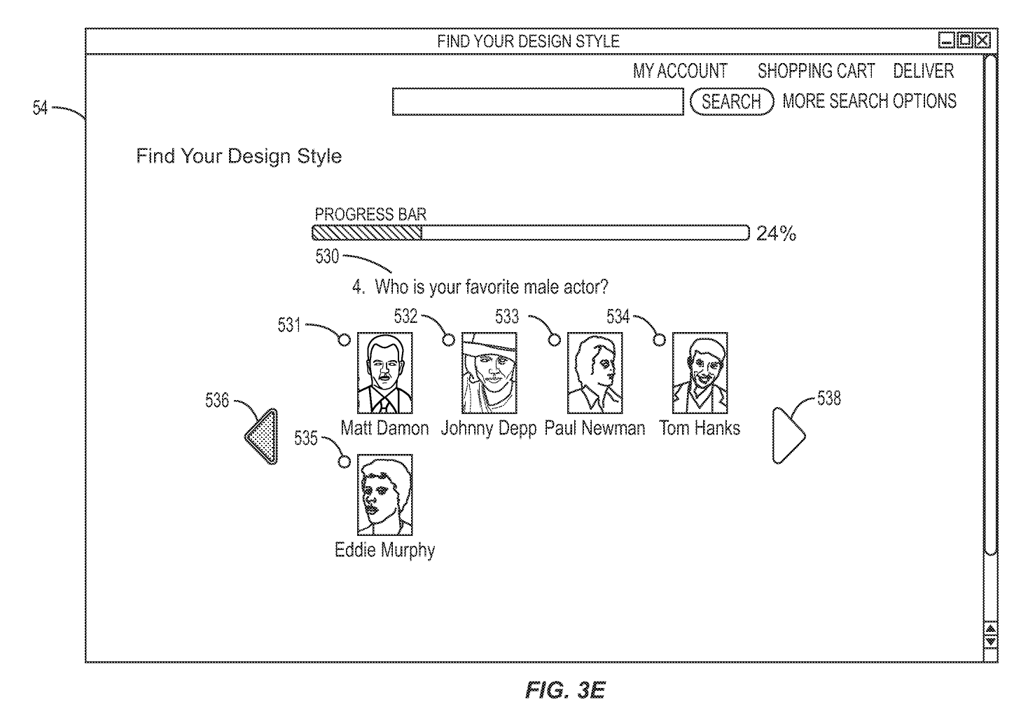

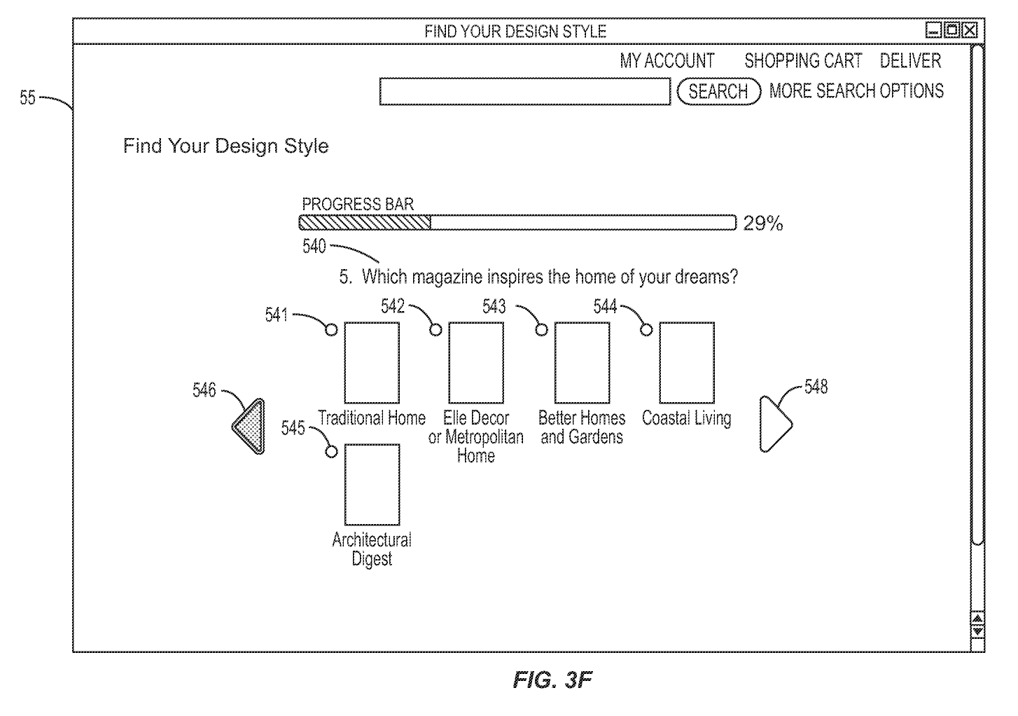

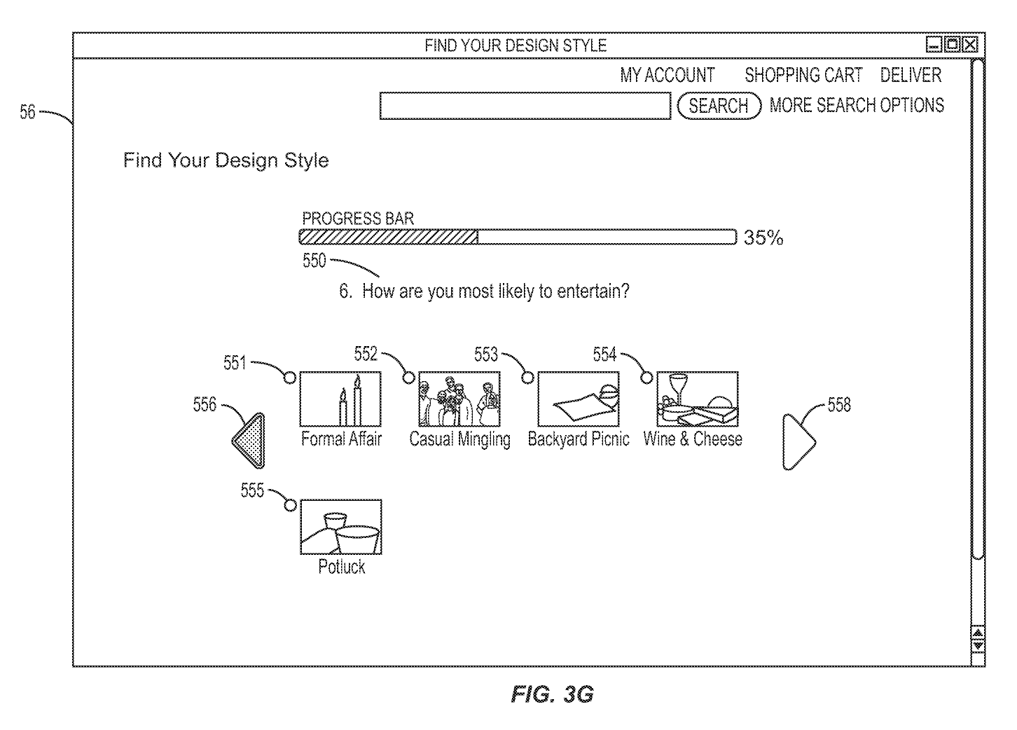

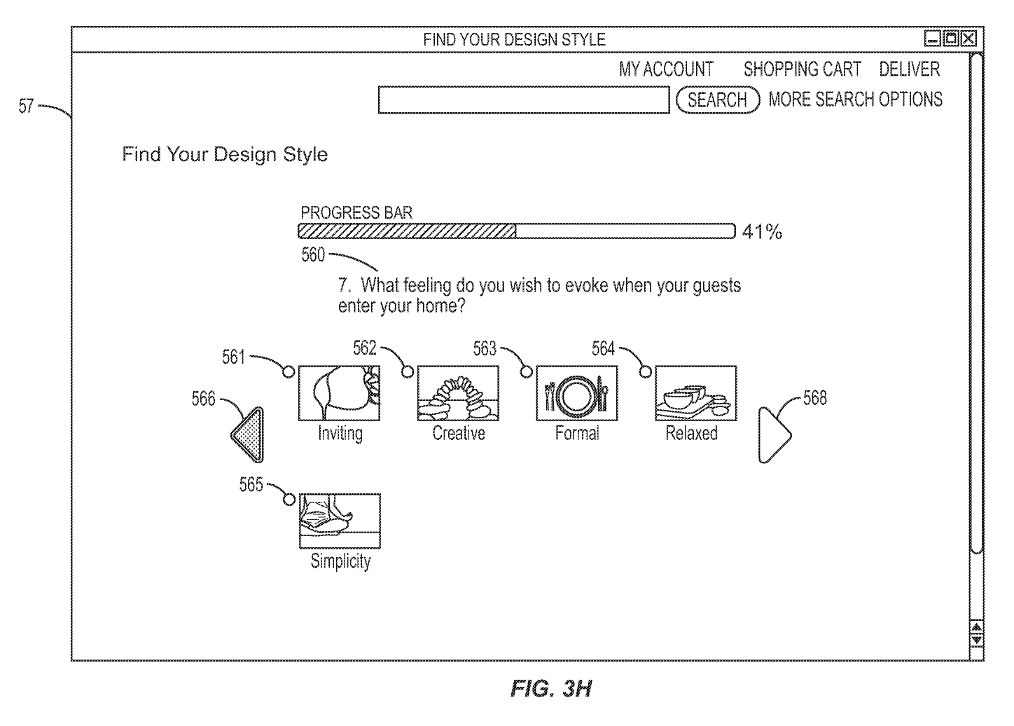

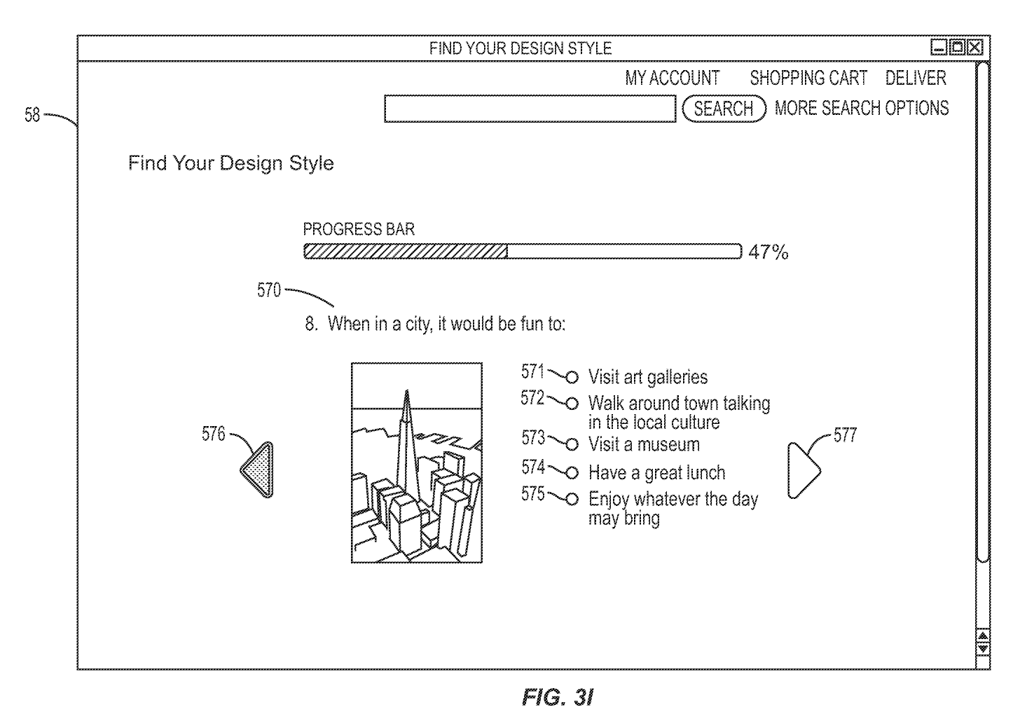

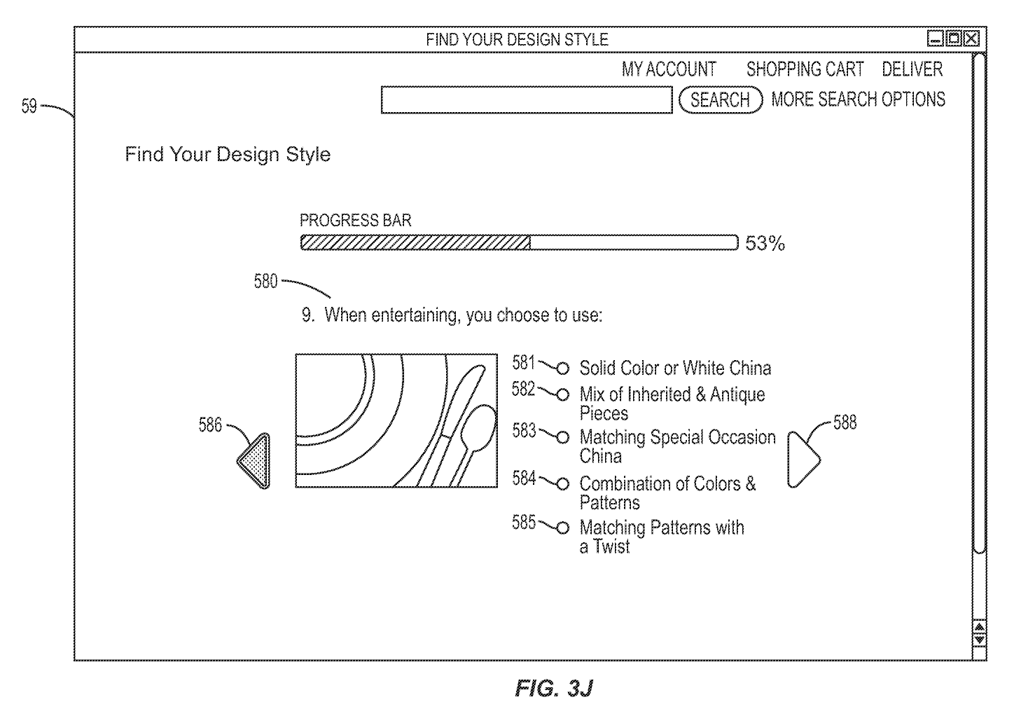

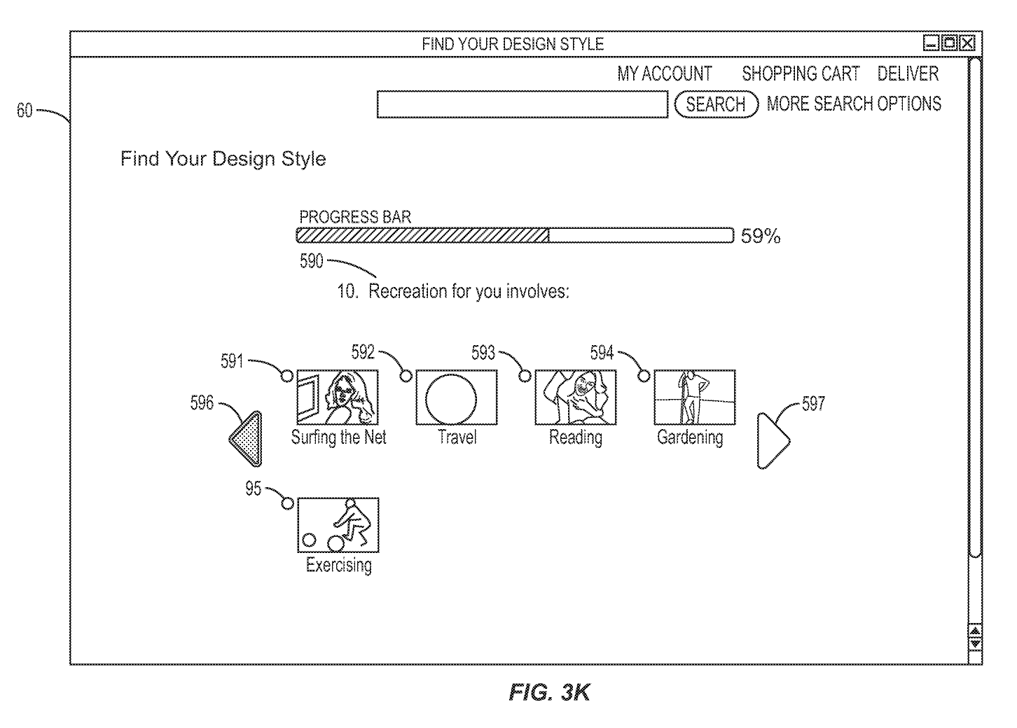

In step 385, the computer program causes the display or transmission of a design category confirmation. This confirmation can confirm the design categories identified, and the primary design category, for the user. In other embodiments, the computer program makes available with the confirmation, a coupon redeemable by the user at one of the seller's retail locations. Returning to step 375, if the user accepts the initial design categories, the process proceeds to step 410 shown in FIG. 3C.

FIG. 2C shows steps 410-440 that relate to the transmission of messages to the user device 200 regarding various aspects of the user's design category information. As shown in FIG. 2C, in step 410, the computer program determines if the user has opted out of receiving messages regarding the user's design categories. If the computer program determines that user has opted out of receiving any messages, the process proceeds to step 420. In step 420, an indication of a user opt-out is stored in a computer memory. In step 410, however, if the user has not opted out of receiving messages, the process proceeds to step 430. In other embodiments, the computer program may be an active opt-in system.

Continuing with FIG. 2C, as shown in step 430, the computer program can determine the content of one or more messages that will be transmitted to the user device 200, based on the user's design categories. The message can include a link, that when selected by the user, provides access to an incentive for the purchase of one or more products associated with one or more of the user's design categories. The incentive can be activateable at a seller's retail location. In another embodiment, the content of the message can include a coupon for one or more products associated with one or more of the user's design categories. The coupon can be redeemable at the seller's retail location. In an embodiment, the seller may also receive a report regarding the user's design categories. The availability of the incentives and/or coupon encourages the user to physically visit the retail location. The in-store visit by the consumers, with her lifestyle preferences correlated to one or more design categories, can facilitate the shopping process for both the consumer and seller. The users can purchase a product within a design category that is based on her lifestyle choices. The seller is able to personally sell products to consumer within the consumer's design categories, which increases the likelihood the consumer is pleased with the purchase. The seller can also, for example use the consumer's design categories to educate and/or match a floor salesperson's characteristics with the particular consumer.

In another embodiment, the message can comprise information other than product offerings related to one or more of the user's design categories. For example, the information can include product information, images, and uses for various products within the user's design category. In yet another embodiment, the message can comprise decorator recommendations related to one or more of the user's design categories or can recommended other products or services, e.g., vacations or real estate ventures, based upon the design categories and/or lifestyle preferences.

In an embodiment, the message may include information regarding the user's primary design category. For example, the message related to the user's primary design category can include a link, that when selected by the user, provides access to an incentive for the purchase of one or more products associated with one or more of the user's primary design category. The incentive can be activateable at a seller's retail location. In another embodiment, the content of the message can include a coupon for one or more products associated with the user's primary design category. The coupon is also redeemable at the seller's retail location.

Continuing with FIG. 2C, in step 440, the computer program can initiate the transmission of one or more messages. For example, an initial message can be transmitted to the user to within 24 hours of completion of the survey, registration, or both. In other embodiments, the messages can be transmitted to the user's device 200 every two weeks, or monthly, or on certain dates, e.g., birthdays, holidays, anniversaries, etc.

### Exemplary Screen Displays

FIGS. 3A through 3K show various screen displays used to identify and display a user's design categories based on the user's lifestyle preferences. In one embodiment, the graphical user interface running on user device 200 can generate a series of screen displays 50, 51, 52, . . . 60, as shown in FIGS. 3A through 3K, that facilitate identification of the user's design categories.

FIG. 3A is an exemplary screen display 50. Screen display 50 can be displayed by selecting a link to a questionnaire on the seller's website (not shown). As shown in display 50, the user can be presented with a button 502 to begin the questionnaire. When a user selects button 502, the user interface causes screen display 51 of FIG. 3B to be displayed on the user device 200. Screen display 51 initiates a 10-question survey to facilitate indentifying the user's design categories. In other embodiments, more or less questions may be used. The displays 3A-3K include exemplary questions for identifying user lifestyle preferences.

FIG. 3B shows display 51 including an exemplary initial question 500 used determine the user's lifestyle preferences related to that question. In the embodiment shown in FIG. 3B, question 500 (“How would your friends describe you?”) has a plurality of choices that include: “Sensible” 501, “Comfortable” 502, “Sophisticated” 503, “Friendly” 504 and “Imaginative” 505. The user may select any of the choices, which cause information regarding that choice to be transmitted or otherwise made available to the third party processors' website 250 (or the seller's website 220 in another embodiment). The computer program can determine the user's score for each design category for that particular question, as described above. This process can be repeated for each question discussed below. When a user selects button 506, the user interface causes the screen display 50 in FIG. 3A to be displayed, and when a user selects button 508, the user interface causes the screen display 52 to be displayed.

FIG. 3C is a screen display 52 showing an exemplary second question 510 and choices 511, 512, . . . 515. In the embodiment shown, question 510 (“When going through home furnishings magazines, how do you like your rooms to be?”) has choices that include: “Clean and Uncluttered” 511, “Full of Interesting Items” 512, “Quaint and Historical” 513, “Comfortable” 514, and “Able To Store a Lot” 515. The selection of any one of the choices is 511 through 515 indicates and user's lifestyle preference with respect to the question 510. When a user selects the button 516 or 518, the user interface causes the display 51 (shown in FIG. 3B) or 53 (shown in FIG. 3D) to be displayed, respectively.

As shown on FIG. 3D, a screen display 53 shows a third question 520 and a plurality of choices 521, 522, . . . 526 intended to indicate a user's lifestyle preference for that particular question. In the embodiment shown, question 520 (“Where are you most likely to find inspiration for the things you love?”) has a plurality of choices that include: “Antique Shops” 521, “Flea Markets” 522, “Magazines” 523, “The Museum of Modern Art” 524, “Home Decorating TV Shows” 525, And “Furniture Stores” 526. When a user selects button 528, the user interface causes display 54 shown on FIG. 3E to be displayed.

FIG. 3E shows a screen display 54 that includes a fourth question 530 and a plurality of choices 531, 532, . . . 535. In the embodiment shown, question 530 (“Who is your favorite male actor?”) has a plurality of choices that include: “Matt Damon”531, “Johnny Depp” 532, “Paul Newman” 533, “Tom Hanks” 534, and “Eddie Murphy” 535. Selection of any one of choices 531 through 538 indicates the user's lifestyle preference for that question. When a user selects button 538, the user interface causes display 55 shown on FIG. 3F to be displayed.

As shown on FIG. 3F, a screen display 55 includes a fifth question 540 and a plurality of choices 541, 542, . . . 545. In the embodiment shown, question 540 (“Which magazine inspires the home of your dreams?”) has choices that include: “Traditional Home” 541, “Elle Decor” 542, “Better Homes and Gardens” 543, “Coastal Living” 544, and “Architectural Digest” 544. The selection of any one of the choices 541 through 545 indicates a user's lifestyle preference for that particular question. When the user selects button 548, the user interface causes display screen display 56 shown in FIG. 3G to be displayed.

As shown on FIG. 3G, a screen display 56 includes a sixth question 550 and a plurality of choices 551, 552, . . . 555. In the embodiment shown, question 550 (“How are you most likely to entertain?”) has a plurality of choices that include: “Formal Affair” 551, “Casual Mingling” 552, “Backyard Picnic” 553, “Wine & Cheese” 554, and “Pot Luck” 555. The selection of any one of the choices 551 through 555 indicates a user's lifestyle preference for that particular question. When the user selects button 558, the user interface causes display screen display 57 shown in FIG. 3H to be displayed.

As shown on FIG. 3H, screen display 57 includes seventh question 560, and a plurality of choices 561, 562, . . . 565. In the embodiment shown, question 560 (“What feeling do you wish to evoke when your guests enter your home?”) has choices that include: “Inviting” 561, “Creative” 562, “Formal” 563, “Relaxed” 564 and “Simplicity” 565. A selection of any one of the choices is an indication of a user's lifestyle preference for question 560. When the user selects button 568, the user interface causes screen display 58 shown in FIG. 3I to be displayed.

As shown in 3I a screen display 58 includes question 570 and a plurality of choices 571, 572, . . . 575. In the embodiment shown, the phrase 570 (“When in a city, it would be fun to:”) is followed by plurality of choices that include “Visit art galleries” 571, “Walk around town taking in the local culture” 572, “Visit a museum” 573, “Have a great lunch” 574, and “Enjoy whatever the day may bring” 575. Selection by the user of a choice 571 through 575 indicates a user's lifestyle preference for completing that phrase. When the user selects button 577, the user interface causes screen display 59 shown in FIG. 3J to be displayed.

As shown in FIG. 3J, screen display 59 includes a ninth phrase 580 that includes a plurality of choices 581,582, . . . 585. The phrase 580 (“When entertaining, you choose to use:”) is followed by a plurality of choices that include: “Solid Color or White China” 581, a “Mix of Inherited Antique Pieces” 582, “Matching Special Occasion China” 583, “Combination of Colors and Patterns” 584, and “Matching Patterns with a Twist” 585. A user may select any one of choices 581 through 585 to complete the phrase 580, which indicates a lifestyle preference for that phrase. When the user selects button 588, the user interface causes screen display 60 shown in FIG. 3K to be displayed.

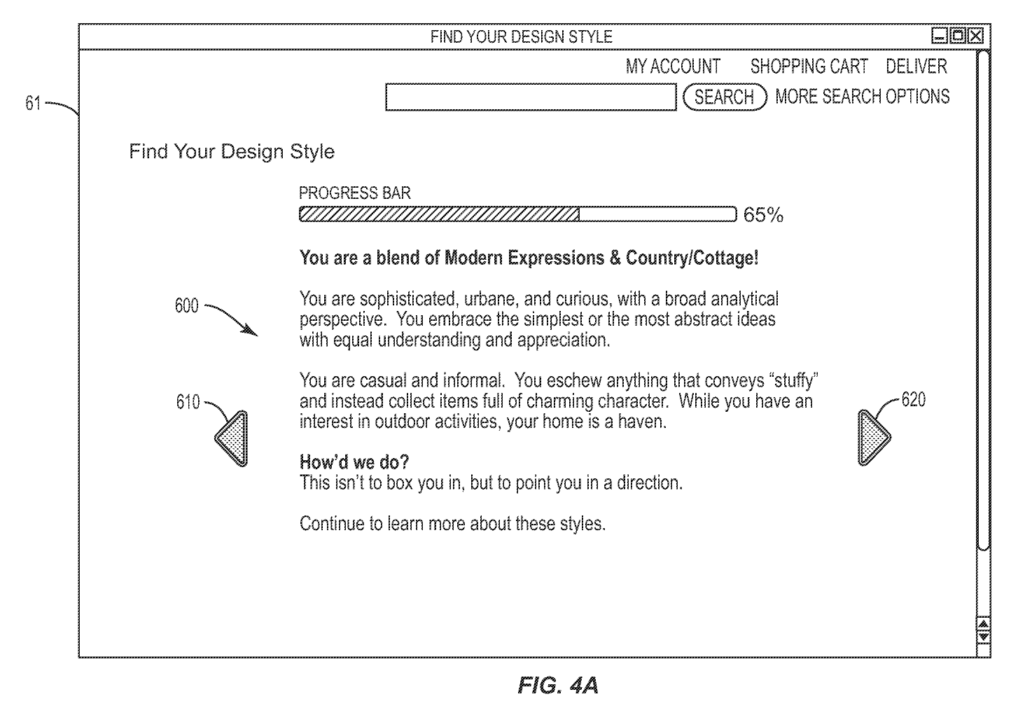

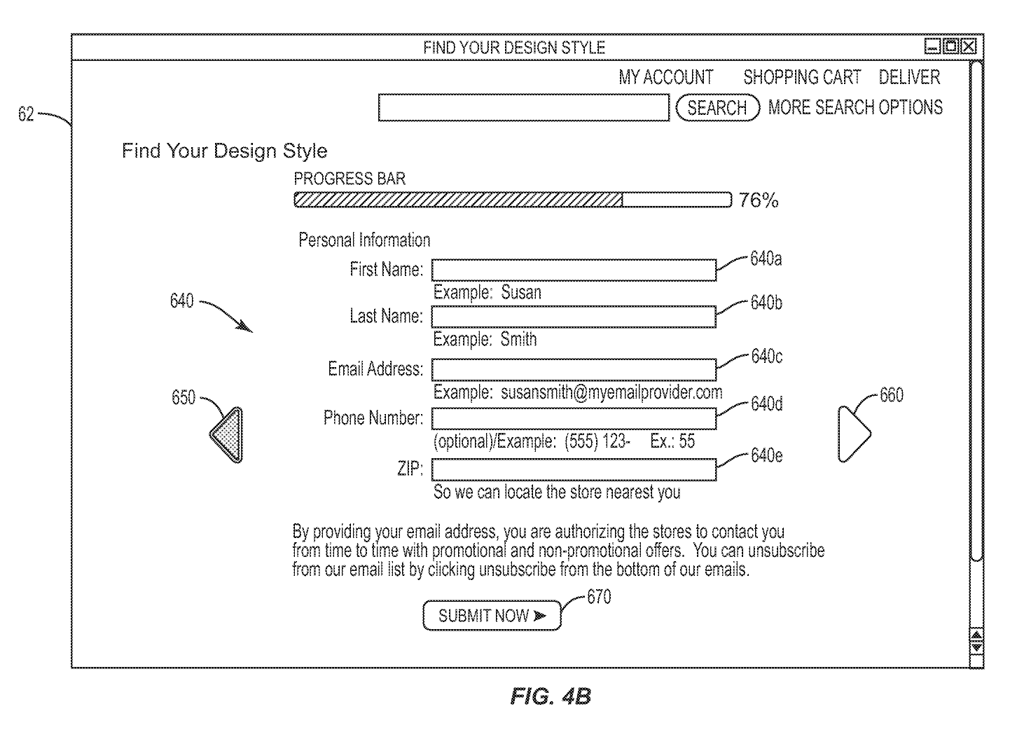

As shown in FIG. 3K, screen display 60 includes question 590 and a plurality of answer choices 591, 592, . . . 595. In the embodiment shown, the phrase 570 (“Recreation for you involves:”) is followed by a plurality choices that complete the phrase, and include: “Surfing the Net” 591, “Travel” 592, “Reading” 593, “Gardening” 594, and “Exercising” 595. A selection of any one of the choices is an indication of the user's lifestyle preference for that particular phrase. When a user selects button 597, the user interface causes the display 61 shown FIG. 4A to be displayed.

As shown on FIG. 4A, screen display 61 includes a summary 600 of the user's design categories. As described above, the summary 600 is based on the user's choices to questions 500 through 590 discussed above. Upon completion of the questions, or while the questions are being completed by the user, an indication of the user's choices can be transmitted or otherwise made available to seller's website 220. The software identifies the user's design categories, and provides textual summary 600 of the user's design categories.

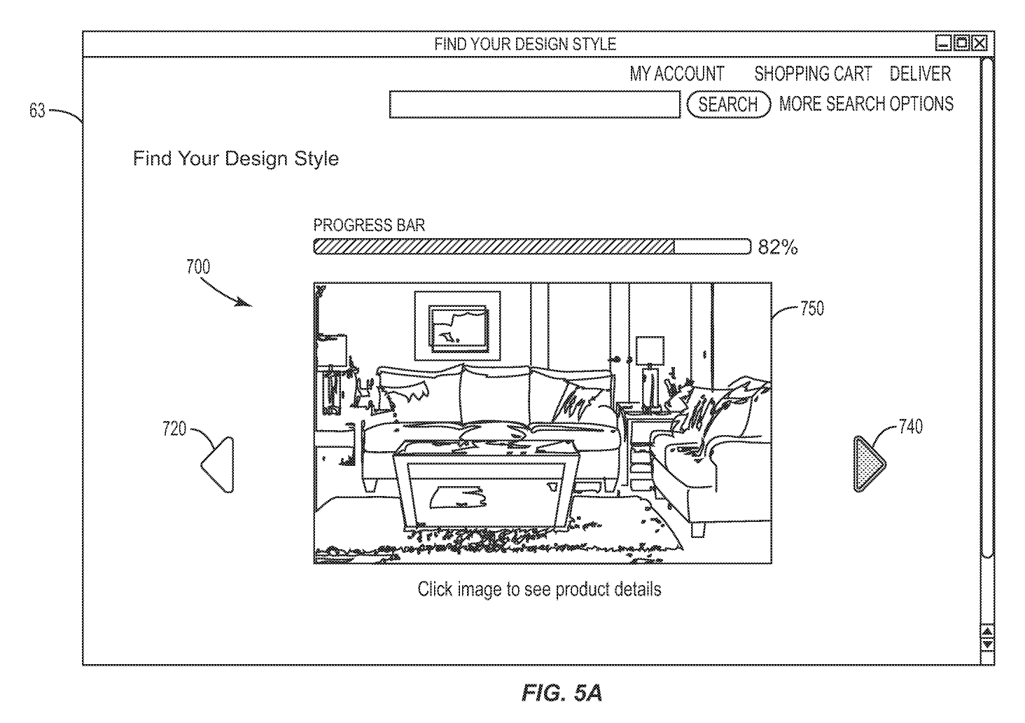

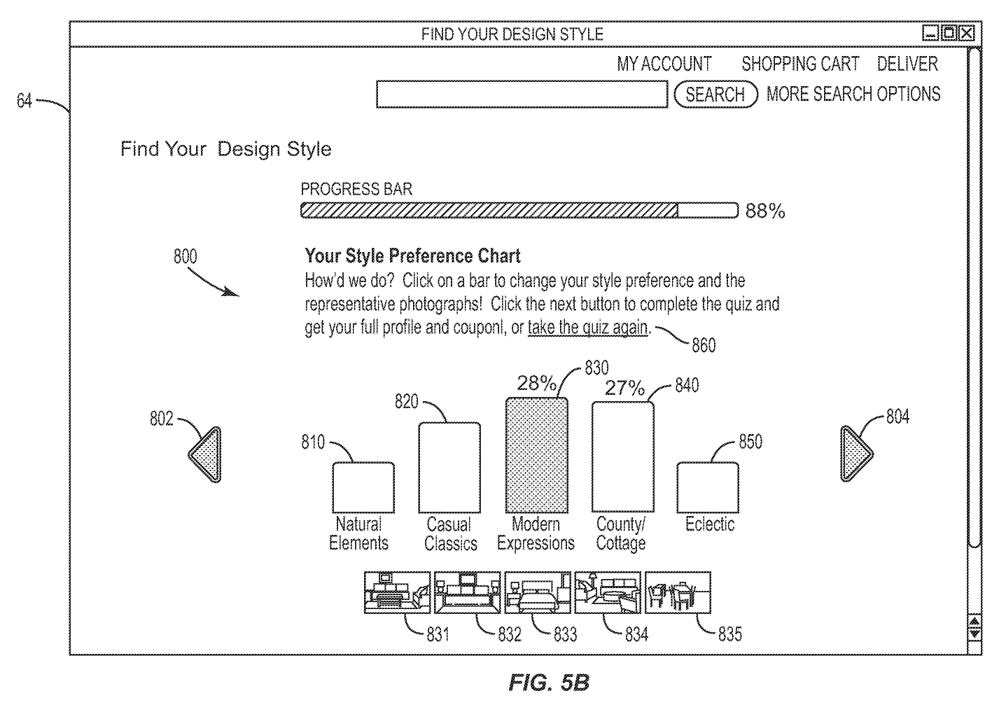

The display 61 shown in FIG. 4A can include buttons 610 and 620. When a user selects button 610, the user interface causes the screen display 59 to be displayed. When a user selects button 620, the user interface causes a display (not shown) that encourages the user to complete registration. When the user decides to complete the registration step, the user interface causes screen display 62 shown at FIG. 4B to be displayed. Screen display 62 includes various fields 640 for a user to input demographic information including, but not limited to, name 640a and 640b, email address 640c, phone number 640d, and zip code 640e. When a user selects button 640, the user interface submits the registration information to the computer system 220 as described above. The user interface then causes display 63 as shown in FIG. 5A to be displayed. The selection of button 650 or 660 cause the user interface to display screen displayed 61, or 63, respectively.

As shown in FIG. 5A, the screen display 63 includes product information 700 for one of the user's identified design categories. For example, the product information can include products associated with the design category “Modern Expressions.” Product information 700 can include an image 750, which can be a hypertext link. Selection of the image causes the graphical user interface to redirect the user's device 200 to a seller's website 250. The seller's website 250 can include products associated with the user's category displayed in display 63. When the user selects button 740, the user interface causes a second display of product information that is associated with another user design category. The displays can provide access to information regarding one or more products associated with the user's design categories. In the embodiment shown, when a user selects button 740, the user interface causes display 64 shown in FIG. 5B to be displayed.

As shown on FIG. 5B, screen display 64 includes the design category information 800. The design category information 800 can include a graphical representation of the user's identified design categories. The exemplary design category information 800 shown in FIG. 5B include “Natural Elements” 810, “Casual Classics” 820, a “Modern Expressions” 830, “Country Cottage” 840, and “Eclectic” 850. Each design category 810, 820, 830, 840 and 850 can be a link, the selection of which can cause the user interface to display further information regarding that design category. In an embodiment, selection by the user of any one of the design categories 810 through 850 will cause the user interface to display product information specific to that design category.

The indication of the user's primary design category is based on the choices to the questions 500 through 590 as discussed above. The user's primary design category is the category with the highest relative score obtained, according to the algorithm discussed above, and further detailed below. In the embodiment shown in FIG. 5B, the user's primary design category would be “Modern Expressions” 830 with a score of 28%, which is higher than any of the other score obtained for the design categories 810, 820, 840, and 850.

Also shown in FIG. 5B are images 831, 832, 833, 834 and 835, which are images of products associated with the “Modern Expressions” category 830. In an embodiment, the images 831, 832, 833, 834, and 835 can be links, which when selected by the user, cause the user interface to provide access to information regarding products associated with the user primary design category, e.g., Modern Expressions in the embodiment shown.

An aspect of the system and method is the ability of the user to “override” the identification of the user's design categories, or primary design categories. For example, the user may select any of the design categories 810 through 850 as his or her primary design category. In addition, the user may retake the questionnaire by selecting the “take the quiz again” link 860. When a user selects link 860, the user interface causes the user to restart the questionnaire (at screen display 51 shown in FIG. 3B), and progress again through questions 500 through 590, eventually the software can display the user's alternate design categories.

Another embodiment of the invention can be a computer implemented system for identifying a user's design categories for one or more products offered by one or more seller's of products. The system can comprise a computer processor that causes the display of a plurality of questions. Each of the plurality of questions associated with a plurality of choices. The computer processor can receive the selections by the user of one or more choices to one or more of the questions. The computer processor receives an indication of at least one of the selected choices to one or more of the plurality of questions. The selected choices comprise lifestyle preferences for the user. The system can include a computer memory having stored thereon the user's lifestyle preferences. The computer processor identifies the user's multiple design categories based on the user's lifestyle preferences. The computer can have stored thereon the user's design categories. The computer processor can also cause the display of user's multiple design categories. The computer process can provide access to an incentive for the purchase of one or more products associated with the user's multiple design categories, wherein the incentive is activatable at a seller's retail location.

In another embodiment, a computer program product can have software for identifying a user's design categories for one or more products offered by one or more sellers of products. The computer program product is comprised of a computer readable medium having stored thereon instructions, which when executed by the processor cause the processor to display a plurality of questions. Each of the plurality of questions associated with a plurality of choices. The instruction causes the computer processor to receive the selection by the user of one or more of the plurality of choices to one or more of the plurality of questions. The computer processor can receive an indication of at least one of the selected choices to one or more of the plurality of questions. The selected choices comprise lifestyle preferences for the user. The computer processor causes the user's lifestyle preferences to be stored in a computer memory. The computer process can identify the user's multiple design categories based on the user's lifestyle preferences and cause the user's design categories to be stored in a computer memory. The computer processor can cause the display of the user's multiple design categories. The computer processor can provide access to an incentive for the purchase of one or more products associated with the user's multiple design categories, wherein the incentive is activatable at a seller's retail location.

In another embodiment, the system, computer-implemented method and a computer-program product can create and maintain a database on lifestyle preferences and design trends based on a plurality of users. Lifestyle preference data can be received directly from a plurality of user's input into the system. In an embodiment, a computer-implemented system, method and a computer-program product can include receiving an indication of at least one of the selected choices to one or more of the plurality of questions. The selected choices comprising lifestyle preferences for the plurality of user's. The computer-implemented system, method and a computer-program product can store in a computer memory lifestyle preferences for a plurality of user's. Demographic information can be received for the plurality of users. The lifestyle preferences and the demographic information for the plurality of users can be maintained in one or more databases. In an embodiment, the information in the databases can be analyzed using pattern recognition, artificial intelligence, and neural networks. The data maintained in the one or more databases can be used to provide consumer insight, trend analysis, improved retailer product selection, target advertising, store merchandising, and can be facilitate overall strategic planning

### Correlation of the Lifestyle Preferences to the Design Categories

Correlating lifestyle preferences with design categories can, in an embodiment, involve “choice weighting” and “question weighting.” In “choice weighting,” percentage weights are associated with each answer choice, according how the answer choice reflects the user's lifestyle preference. Each question can have a number of choices, for example 6. More or less choices can be used. Each choice is given a set of percentages, one for every category the survey includes. The percentages for each choice should add up to 100%. In one exemplary embodiment, the design categories include Contemporary, Eclectic, Modern, Rustic, Traditional, and Transitional. Each percentage below represents the design categories' weight, what “weight” for that questions. Below is an exemplary question with four choices:

If you had to choose from the below palettes, what best describes your taste in color?
a. Jewel tones (deep red, eggplant, emerald, gold)
b. Neutral (beige, taupe, khaki, white, off white)
c. Earth tones (rich brown and tan, grey, green, blue and touches of red)
d. Electric (lime, fuchsia, purple, red, yellow and blue)

Each choice a, b, c, and d, would include the following values for each category:
a. Jewel (50% Traditional, 25% Transitional, 25% Eclectic)
b. Neutral (100% Modern)
c. Earth tones (100% Rustic)
d. Electric (50% Eclectic, 10% Contemporary, 25% Modern, 15% Transitional)

For each choice (a, b, c, and d) the percentages for the design categories should add up to 100%. However, each design category does not need to be represented in the choice.

Question weighting associates a value with each question and quantifies the importance of a particular question. For example, take the following questions:
1) What feeling do you wish to evoke when your guest enter your home?
2) If you had to choose from the below palette's, what best describes your taste in color?

Question weighting can start with a value. In the above example, Question 1 can have a value of 100 points. If Question 2 above is considered more indicative of a user's style preference over question 1, the Question 2 value is increased to 110 points. If, however, question 2 is less indicative of a user's design categories, the value for that question can be set to 95 points.

Indentifying a user's score for each design category occurs by multiplying the “choice weight” to the “question weight.” For example, in the question above, assume the user has picked choice a. Jewel Tones. The user will score like this:

50% Traditional*95 points=47.5 Traditional points

25% Transitional*95 points=23.75 Transitional points

25% Eclectic*95 points=23.75 Eclectic points

At the end of the survey, the system calculates what the highest potential point tally is for each design category. For example, the maximum totals for Contemporary, Eclectic, Modern, Rustic, Traditional, and Transitional design categories are shown in table 1 below.

TABLE 1

| Category | Max Point Total |
|---|---|
| Contemporary | 295 |
| Eclectic | 65 |
| Modern | 100 |
| Rustic | 100 |
| Traditional | 100 |
| Transitional | 100 |

For the Contemporary category, the highest score any user could ever score by picking the choice associated with high choice values for that category is 295 and likewise 65 for Eclectic, 100 for Rustic, Traditional, and Transitional categories.

At the end of the survey, the system calculates the user's actual score. For example, the user may have selected choices to the questions that provided raw scores for each design categories as shown in the table 2 below.

TABLE 2

| Category | Max Point Total |
|---|---|
| Contemporary | 100 |
| Eclectic | 60 |
| Modern | 20 |
| Rustic | 20 |
| Traditional | 20 |
| Transitional | 20 |

As shown in table 2 above, the raw number of points the user scored in Contemporary category is 40 pts higher than their score in the Eclectic category.

The user's score is reflected as a percentage of the maximum possible point value for each category. For the Contemporary category, this score is roughly 33% [(100/295)*100=33.8%). For the Eclectic category, the score is about 92% [(60/65)*100=92.3%]. This same calculation occurs for every category. The percentages for each design category are reflected in the display of the user categories.

Exemplary Questions and Choices with Weighting

1. (220%) What is the overall feeling you wish to create within your home?
a. Sophisticated (traditional 25% transitional 25% cottage 20% modern 20% contemporary 10% eclectic 0%)
b. Formal (traditional 40% transitional 30% cottage 0% modern 15% contemporary 15% eclectic 0%)
c. Cozy, Casual and/or Rustic (traditional 0% transitional 20% cottage 40% modern 0% contemporary 0% eclectic 40%)
d. Chic and Sleek (traditional 0% transitional 0% cottage 0% modern 50% contemporary 50% eclectic 0%)
e. Bohemian or Eclectic (traditional 0% transitional 0% cottage 25% modern 15% contemporary 10% eclectic 50%)
f. Exotic or Mysterious (traditional 0% transitional 25% cottage 25% modern 20% contemporary 0% eclectic 30%)
g. Dramatic (traditional 15% transitional 15% cottage 20% modern 20% contemporary 0% eclectic 30%)
h. Urban or Lofty (traditional 0% transitional 0% cottage 0% modern 50% contemporary 50% eclectic 0%)

2. (145%) Where are you most likely to find inspiration for the things you love?
a. Antique Shops (traditional 40% transitional 0% cottage 30% modern 0% contemporary 0% eclectic 30%)
b. Flea Markets (traditional 20% transitional 20% cottage 30% modern 0% contemporary 0% eclectic 30%)
c. Magazines (traditional 20% transitional 30% cottage 30% modern 10% contemporary 0% eclectic 10%)
d. The Museum of Modern Art (traditional 0% transitional 10% cottage 0% modern 50% contemporary 40% eclectic 0%)
e. Home Decorating TV Shows (traditional 25% transitional 20% cottage 15% modern 15% contemporary 15% eclectic 10%)
f. Furniture Stores (traditional 30% transitional 30% cottage 10% modern 10% contemporary 10% eclectic 10%)

3. (195%) Which magazine inspires the home of your dreams?
a. Traditional Home (traditional 90%, transitional 10%)
b. Elle Decor or Metropolitan Home (modern 33%, contemporary 33%, transitional 33%)
c. Better Homes and Gardens (transitional 40%, country 40%, traditional 20%)
d. Real Simple or Martha Stewart (cottage 50%, transitional 25%, eclectic 10%, traditional 15%)
e. Coastal Living (cottage 50%, contemporary 25%, eclectic 25%)
f. Architectural Digest (traditional 40%, contemporary 30%, eclectic 30%)
g. Domino (transitional 40%, modern 20%, eclectic 40%)

4. (100%) If you were to dress your home in your favorite clothing brand, which one would you choose?
a. Ralph Lauren/Coach (traditional 50%, transitional 30%, Cottage 10%, Eclectic 10%)
b. Liz Claiborne (Traditional 55%, transitional 45%, cottage 0%, modern 0%, contemporary 0%, eclectic 0%)
c. Eddie Bauer/Lands End (cottage 40%, traditional 35%, Transitional 15%, Eclectic 10%)
d. Prada/Vera Wang/Louis Vuitton (traditional 30%, contemporary 35%, modern 35%)
e. Tommy Bahama or Lily Pulitzer (cottage 40%, Eclectic 35%, Trans 25%)
f. Banana Republic, JCrew (modern 70%, contemporary 20%, traditional 10%)

5. (100%) Which texture do you most love to touch?
a. Tweed (traditional 40%, transitional 25%, cottage 5%, modern 0%, contemporary 10%, eclectic 20%)
b. Silk (traditional 35%, transitional 10%, cottage 0%, modern 10%, contemporary 35%, eclectic 10%)
c. Suede (traditional 10%, transitional 30%, cottage 10%, modern 20%, contemporary 15%, eclectic 15%)
d. Cut velvet (traditional 20%, transitional 10%, cottage 0%, modern 15%, contemporary 15%, eclectic 40%)
e. Leather (traditional 20%, transitional 20%, cottage 10%, modern 20%, contemporary 20%, eclectic 10%)
f. Polished cotton (traditional 35%, transitional 10%, cottage 35%, modern 10%, contemporary 0%, eclectic 10%)

6. (50%) How are you most likely to entertain?
a. Formal affair with your dining and living room
(traditional 60%, contemporary 40%)
b. Casual mingling throughout your home
(traditional 25%, transitional 25%, modern 15%, eclectic 20%, cottage 15%)
c. Backyard Picnic
(cottage 40%, transitional 40%, eclectic 20%)

7. (100%) What feeling do you wish to evoke when your guests enter your home
a. Inviting (traditional 30%, transitional 15%, cottage 30%, modern 0%, contemporary 0%, eclectic 25%)
b. Creative Atmosphere (traditional 0%, transitional 30%, cottage 0%, modern 15%, contemporary 15%, eclectic 40%)
c. Formal (traditional 40%, transitional 10%, cottage 0%, modern 10%, contemporary 40%, eclectic 0%)
d. Relaxed (traditional 0%, transitional 15%, cottage 50%, modern 0%, contemporary 0%, eclectic 35%)
e. Simplicity and Minimalism (traditional 0%, transitional 10%, cottage 0%, modern 45%, contemporary 45%, eclectic 0%)

8. (130%) Which is your favorite color palette?
a. Dramatic—reds, yellows, blues and greens, including jewel tones (transitional 45%, modern 35%, contemporary 10%, eclectic 10%)
b. Understated—quieter, toned versions of reds, yellows, blues and greens (traditional 25%, transitional 25%, modern 25%, contemporary 25%)
c. Neutral—an earth tones, browns, tans, greys, bottle greens, cadet blues and terracotta, eggplant (transitional 35%, cottage 30%, eclectic 10%, traditional 25%)
d. Electric—intense limes, fuschias, purples, reds, yellows, oranges and blues (modern 30%, contemporary 40%, eclectic 30%)

9. (210%) Which of the following wood finishes do you prefer?
a. Dark wood (traditional 35%, transitional 20%, modern 35%, eclectic 10 b. Light wood (transitional 35%, modern 25%, contemporary 30%, eclectic 10%)
c. Medium wood (traditional 30%, transitional 30%, cottage 30%, eclectic 10%)
d. Black, white or painted (cottage 35%, eclectic 30%, contemporary 25%, modern 10%)
e. High Gloss or lacquer (modern 50%, contemporary 50%)

10. (90%) What destination would most likely inspire your personal style?
a. England/France (traditional 65%, Eclectic 20%, Transitional 15%)
b. Italy (traditional 40%, modern 25%, contemporary 25%, transitional 10%)
c. Tropical Islands/Africa/West Indies (cottage 40%, transitional 30%, eclectic 30%)
d. Cape Cod/Nantucket (cottage 45%, trans 25%, eclectic 30f %)
e. New York City/SoHo (modern 40%, contemporary 20%, traditional 20%, Eclectic 20%)
f. Miami/South Beach (contemporary 40%, modern 30%, eclectic 20%, cottage 10%)

In an embodiment, the computer-implemented system, method and a computer-program product can assist in the identification of consumer design categories in the home furnishings industry, fashion, home decorating accessories, apparel, real estate, and auto and recreational vehicle industries.

A plurality of questions with answer choices are described herein as one way to receive input regarding the user's lifestyle preferences. In alternate embodiments, however, games, puzzles, or various other survey formats can be used to receive input regarding the user's lifestyle preferences. For example, the computer-implemented system, method and a computer program product can display a game. As the user plays the game, his or her lifestyle preference can be received and stored in a computer memory.

In view of the above descriptions of embodiments of the invention, a person of ordinary skill in the art will recognize that certain modifications can be made to the described embodiments without departing from the scope of the invention. For example, any combination of the features described above can be used with one another, alone or in combination. All such modifications and combinations are intended to be within the scope of the invention.

1.-8. (canceled)

9. A computer-implemented method for identifying a user's design categories for one or more products offered by one or more sellers of products, the method comprising:
a. displaying, via a user interface, a plurality of questions, each of the plurality of questions associated with a plurality of choices;
b. permitting selection by the user of one or more of the plurality of choices to one or more of the plurality of questions;
c. receiving an indication of at least one of the selected choices to one or more of the plurality of questions, the selected choices comprising lifestyle preferences for the user;
d. storing in a computer memory the user's lifestyle preferences;
e. identifying, via a computer processor, the user's design categories based on the user's lifestyle preferences;
f. storing in the computer memory the user's design categories;
g. displaying, via the user interface, the user's multiple design categories; and
h. providing access to information regarding one or more products associated with a seller that corresponds to the user's multiple design categories.

10. The method of claim 9, further comprising transmitting to the user at least one message, the at least one message comprising information other than product offerings related to the user's multiple design categories.

11. The method of claim 9, further comprising transmitting to the user at least one message, the at least one message comprising design recommendations related to the user's multiple design categories.

12. The method of claim 9, further comprising transmitting to the user at least one message, the message comprising a coupon for one or more products associated with the user's multiple design categories, the coupon redeemable at the seller's retail location.

13. The method of claim 9, wherein the step identifying the user's multiple design categories based on the user's lifestyle preferences further comprises identifying a user's primary design category.

14. The method of claim 13, further comprising transmitting to the user at least one message, the at least one message comprising design recommendations related to the user's primary design category.

15. The method of claim 14, further comprising transmitting to the user at least one message, the message comprising information related to the user's primary design category and one or more products available for purchase that correspond to the user's primary design category.

16. The method of claim 9, further comprising receiving registration information, the user registration information identifying the user, receipt of the registration information being a prerequisite to the display of the user's multiple design categories.

17. A computer-implemented method for identifying a user's design categories for one or more products offered by one or more sellers of products, the method comprising:
i. displaying, via a user interface, a plurality of questions, each of the plurality of questions associated with a plurality of choices;
j. permitting selection by the user of one or more of the plurality of choices to one or more of the of the plurality of questions;
k. receiving an indication of at least one of the selected choices to one or more of the plurality of questions, the selected choices comprising lifestyle preferences for the user;
l. storing in a computer memory the user's lifestyle preferences;
m. identifying, via a computer processor, the user's multiple design categories based on the user's lifestyle preferences;
n. storing in the computer memory the user's design categories;
o. displaying, via the user interface, the user's multiple design categories; and
p. transmitting, via the communications network, to the user at least one message, the at least one message comprising information other than product offerings related to the user's multiple design categories.

18. The method of claim 17, further comprising providing access to information regarding one or more products associated with a seller that corresponds to the user's multiple design categories.

19. The method of claim 17, further comprising transmitting to the user at least one message, the at least one message comprising design recommendations related to the user's multiple design categories.

20. The method of claim 17, further comprising transmitting to the user at least one message, the message comprising a coupon for one or more products associated with the user's multiple design categories, the coupon redeemable at the seller's retail location.

21. The method of claim 17, further comprising receiving registration information, the user registration information identifying the user, receipt of the registration information being a prerequisite to the display of the user's multiple design categories.

22. A computer-implemented method for identifying a user's design categories for one or more products offered by one or more sellers of products, the method comprising:
q. displaying, via a user interface, a plurality of questions, each of the plurality of questions associated with a plurality of choices;
r. permitting selection by the user of one or more of the plurality of choices to one or more of the of the plurality of questions;
s. receiving an indication of at least one of the selected choices to one or more of the plurality of questions, the selected choices comprising lifestyle preferences for the user;
t. storing in a computer memory the user's lifestyle preferences;
u. identifying, via a computer processor, the user's design categories based on the user's lifestyle preferences;
v. storing in the computer memory the user's design categories;
w. displaying, via the user interface, the user's multiple design categories; and
x. permitting the user to identify one or more alternate design categories.

23. The method of claim 22, wherein the step of permitting the user to identify one or more alternate design categories further comprises permitting the user to select one or more of the design categories displayed as the alternate design category.

24. The method of claim 22, further comprising receiving registration information, the user registration information identifying the user, receipt of the registration information being a prerequisite to the display of the user's multiple design categories.

25. The method of claim 9, further comprising providing access to an incentive for the purchase of one or more products associated with the user's multiple design categories, wherein the incentive is activatable at a seller's retail location.
